(19) United States
(12) Patent Application Publication
(10) Pub. No.: US 2011/0289593 A1
(43) Pub. Date: Nov. 24, 2011

(54) MEANS TO ENHANCE THE SECURITY OF DATA IN A COMMUNICATIONS CHANNEL

(76) Inventors: Alexander Roger DEAS, Dalkeith (GB); David COYNE, Glenrothes (GB)

(21) Appl. No.: 13/114,421

(22) Filed: May 24, 2011

Related U.S. Application Data
(60) Provisional application No. 61/347,525, filed on May 24, 2010.

(51) Int. Cl. H04N 7/16

(52) U.S. Cl. 726/26

(57) ABSTRACT

A technique and method for creating a provably secure communications channel between two devices making the observation, recovery and modification of the data within the communications channel difficult. Specifically, the present invention compromises a technique and method for protecting the data within a data channel where security must be assured.

### BACKGROUND OF THE INVENTION

1. Technical Field

The present invention relates to providing secure data transfers in a potentially insecure communications channel. Specifically, the present invention relates to a technique and methods of transmitting data over a communications channel where the data eye diagram is deliberately closed, making observation or deciphering of the data more difficult for an observer.

2. Background of the Invention

Many integrated circuits are intended for use in secure applications such as smart cards. Communications between a smart card and a terminal or between any two communications devices over a channel that may not be secure poses a problem for the security of the complete system.

FIG. 1 shows an example of communications system 1 with first transceiver 10, communications channel 20 and second transceiver 30. Communications channel 20 comprises a number of networks 21, 22 and 23 that may differ in respect to each other but having a common property of modifying amplitude and phase of signals propagating through the networks. Transceiver 30 is shown with a clock source 40 and clock 41 synchronising data transmitted from said transceiver and synchronising data received by said transceiver. Transceiver 10 is similar to transceiver 30 but without a clock source relying on transceiver 30 to send a clock for synchronisation purposes. Transceiver 30 contains a transmitter 31 synchronising data signal 32 to clock 41 and producing signal 33 to send to transceiver 10 through channel 20 and network 21. Transceiver 30 transmits clock 41 through channel 20 and network 23 to transceiver 10 for use in transceiver 10 as a means of providing synchronisation between transceiver 30 and transceiver 10. Transceiver 30 has a synchroniser 34 to receive data transmitted from transceiver 10, sampling the data on input 35 and producing an output 36. Transceiver 10 has synchroniser 14 sampling data signal 15 received from transceiver 30 with clock 18 producing output 16. Transceiver 10 has a transmitter 11 synchronising data 12 to clock 18 producing output 13 to channel 20 and network 22 passing ultimately to transceiver 10 input 35.

A system as shown in FIG. 1 provides a means of communication between two devices with synchronism of data in each signal path between the two devices. There is a limitation in the maximum data rate of communications system 1 due to phase and amplitude distortion in networks 21, 22 and 23 of channel 20. The effect of non-infinite bandwidth in the networks of channel 20 is to make the received eye diagram more closed making setting of the optimal receive data sample point more difficult. Operation of a communications system at too high a data rate will result in errors in the sampling of data at the receiver. Techniques exist to maximise the data rate of communications system and increase the received data eye diagram opening and align the eye opening to a sampling clock.

In a communications system such as shown in FIG. 1 where a single clock source is used at one of the two transceivers and the clock passed between the two transceivers through the communications channel, there may be some differential phase difference between data and clock paths through the communications channel, for example the wire lengths in networks 21, 22 and 23 may be different. The optimal sampling point of the received data is the centre of the eye diagram of the received data and means are used to align the clock to the received data, for example, using a delayed line. Such techniques are required at high data rates.

In another communications system the clock may not be shared between the two transceivers. Techniques are then employed to perform clock recovery from the data. The data may be encoded in a manner where there is a guaranteed component in the spectral content of the received data that would allow the clock to be recovered and aligned to the data. Another method is to add a preamble to the transmitted data to aid a phase locked loop in the receiver to synchronise to the data periodically.

In other communications systems the characteristics of the networks in the channel may be such that the received signal is severely distorted to the point where the clock eye diagram is almost closed. Advanced techniques may be employed to render the communications system usable such as transmit signal de-emphasis, the use of a decision feedback equaliser in the receiver, the use of a feed-forward equaliser in the receiver or a combination of one or all of these techniques.

FIG. 2a shows an eye diagram that may exist, for example, at the transmitter output of a communications system where the data is transmitted at 50 Mbps with only minimal clock jitter. To recover the data at the transmitter output would require a sampling clock generated from the transmitted data and aligned to the optimal sampling point which would be the centre of the open eye diagram. FIG. 2b shows an eye diagram such as may be viewed at the receiver input of a communications system where the channel network has distorted the signal reducing the eye opening significantly. It is difficult to place a generate a sampling signal with simple clock alignment techniques but the data may still be observed by the use of clock and data recovery methods and or equalisation methods as previously discussed.

In the communications systems outlined above a fixed frequency clock is employed and is mandated for clock recovery and optimal sampling of the received data to achieve a low bit error rate. Further the transmitter eye diagram is always open in order to ensure that distortions in the channel do not totally close the eye diagram at the receiver input making clock and data recovery impossible. Yet further, in the communications systems outline above great lengths are taken to be able to open the eye diagram of the received data and recover the clock and data. It is inherent to the operation of all the above communications system that the received data eye diagram can be opened using one or more known techniques. In all such communications systems where it is possible for a receiver to recover data then it is also possible for an observer to intercept the data, at the transmitter output or even at the receiver input, construct a circuit to observe and decipher the data in a link within a communications channel.

Some forms of algorithmic encoding make it more difficult to identify the clock-data eye of the stored data. In particular, self-shortening linear feedback shift register (LFSR) encoding, can make it difficult to match data bits sent over a channel with fixed clock strobe positions. However, an observer may still capture the data sent because the clock-data eye of the data transmitted is always open.

LFSR encryption may seem to be a step away from one-time pad encryption that is provable secure, but in fact the LFSR encrypted message can be decoded in linear time by an observer as soon a piece of plain text is sent that is longer than the shift register: the LFSR is simply a counter that increments in a sequence that appears pseudo-random. As soon as the full LFSR state is known, from a piece of plain text then all subsequent states are known and the message is trivially decoded. Plain text is often available because file types such as Adobe PDF files, MS Offfice documents and IBM Lotus or Symphony documents comprise the bulk of file transmissions and these all have a long header, font references etc which are as good as plain text for vulnerability purposes. Similarly the self-shortening LFSR encoding is also vulnerable to plain text attacks, and can be decrypted in linear time by an observer once sufficient plain text has been received. The observer can store data sent using self-shortening LFSR encryption and scan it for plain text as file offset positions.

The present invention differs fundamentally from self-shortening LFSR encryption in that the observer cannot capture the data itself because there is no opening in the clock-data eye diagram unless the observer already has the key and sufficient precision of hardware to use the key.

All forms of algorithmic encryption have the hazard that the encrypted data can be observed and stored for subsequent analysis. Decryption may become possible by discovery of the key due to a weakness in the encryption such as the LFSR example above, lack of understanding of Number Theory such the linear time Trace-1 Elliptic Curve solution announced by N. Smart, T. Satoh and K. Araki in 1997 and published by I. A. Samaev in the journal “Mathematics of Computation” 1998, or polynomial time Hyper-Elliptic Curve solutions exhibited by L. Adleman, J. DeMarrias and M-D Huang in 1994, or discovery of a better means to solve the difficult problem that the encryption exploits: when this occurs, all messages every sent using that method are at risk because any of them may have been stored.

Thus it would be beneficial to have a means of transmitting and receiving data in a communications system where the data may not be so easily monitored and thereby enhancing the security of the communications system. Ideally, it is desirable to have the data unobservable within the channel. Such a channel encryption would be unobservable, in that an observer could not collect the data in the channel for subsequent decryption, unless the observer already had the key.

A communications channel with a fully closed clock-data eye diagram, has zero information content to an observer if every cycle is closed. If the clock-eye diagram is closed over a plurality of cycles, the information content can be very close to zero. This is the goal of the ideal encryption system: unobservable data.

### OBJECT OF THE PRESENT INVENTION

It is a primary objective of the present invention to improve the security of a communications channel with a provably secure means, namely the closure of the eye diagram of the data within the communications channel.

It is a further objective of the present invention to provide a means of monitoring the alignment of the optimal sampling clock in a receiver and maintaining optimal alignment in the presence of phase shift between a transmitter and receiver that builds up due to jitter accumulation, to enable the appropriate jitter compensation or jitter tracking to be applied.

### BRIEF SUMMARY OF THE INVENTION

The present invention relates to a technique and methods to improve the security of a device communicating to another device through a communications channel wherein the data in the communications channel is randomly modulated in time to close the data eye diagram securing the data against observation by an intruder.

What is disclosed in the present invention is a first device for transmitting data and a second device for recovery of said transmitted data, the data transmitted from the transmitter to a receiver through a communications channel, the transmit data eye diagram and received data eye diagram are both closed and without a fixed frequency clock, thereby securing data within the link from the transmitter output to the receiver input from observation by an observer. If a data eye diagram is closed, then the data contains no information for an observer.

The transmit eye diagram is closed through the use of a first clock generator, the transmit clock generator, the random properties of the first clock generator bounded by the channel propagation properties. The receiver contains a means of synchronising the data with a second clock generator, the receiver sampling clock generator. Additionally, the receiver includes a means to track jitter accumulation from the transmitter and receiver clock generators.

### BRIEF DESCRIPTION OF THE SEVERAL VIEWS OF THE DRAWINGS

For a better understanding of the present invention and the advantages thereof and to show how the same may be carried into effect, reference will now be made, by way of example, without loss of generality to the accompanying drawings in which:

FIG. 1 shows a diagram of a prior art communications system with a first transceiver, a second transceiver and a communications channel.

FIG. 2a shows a timing diagram that may be observed at the output of a transmitter in a communications system showing a wide open data eye diagram.

FIG. 2b shows a timing diagram that may be observed at the input of a receiver in a communications system showing an almost closed data eye diagram.

FIG. 3 shows a diagram of a communications system in an embodiment of the present invention with a first transceiver, a second transceiver and a communications channel.

FIG. 4a shows a timing diagram of a transmit clock in one embodiment of the present invention.

FIG. 4b shows a timing diagram of a transmit clock, a receive clock and the method used to calculate optimal sampling point of the receive clock in one embodiment of the present invention.

FIG. 5 shows a diagram of a communications system in an embodiment of the present invention reconfigured to measure the communications channel delay and communications channel minimum allowable transmit pulse width.

FIG. 6 shows a diagram of a transmitter in one embodiment of the present invention.

FIG. 7 shows a diagram of one embodiment of the transmit delay line in the present invention.

FIG. 8 shows a diagram of a receiver in a first embodiment of the present invention.

FIG. 9 shows a timing diagram of transmit and receive signals in the present invention along with an additional signal used for enhanced synchronisation.

FIG. 10 shows a receiver in a second embodiment of the present invention with the generation of an additional signal used for enhanced synchronisation.

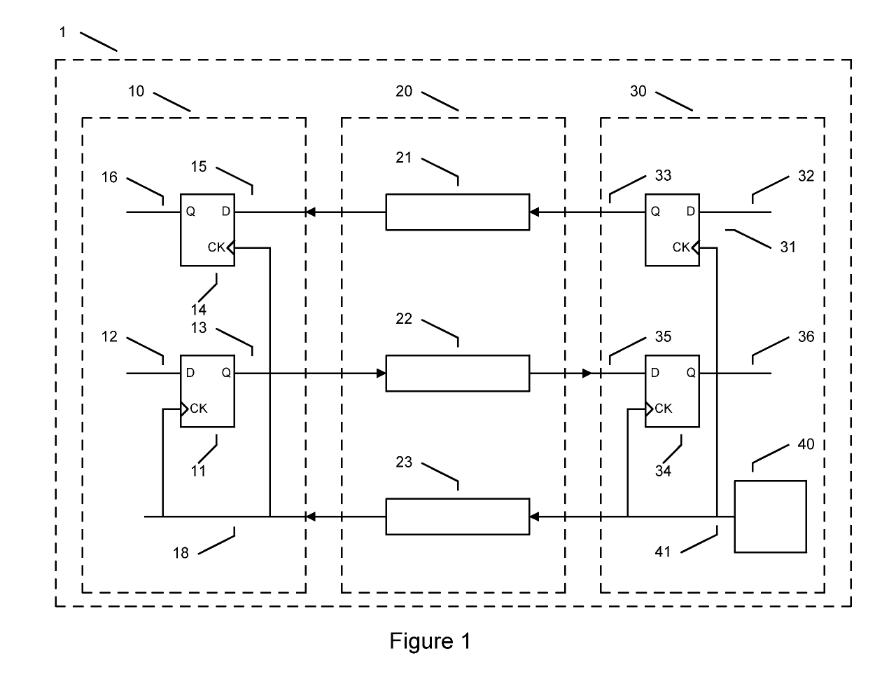

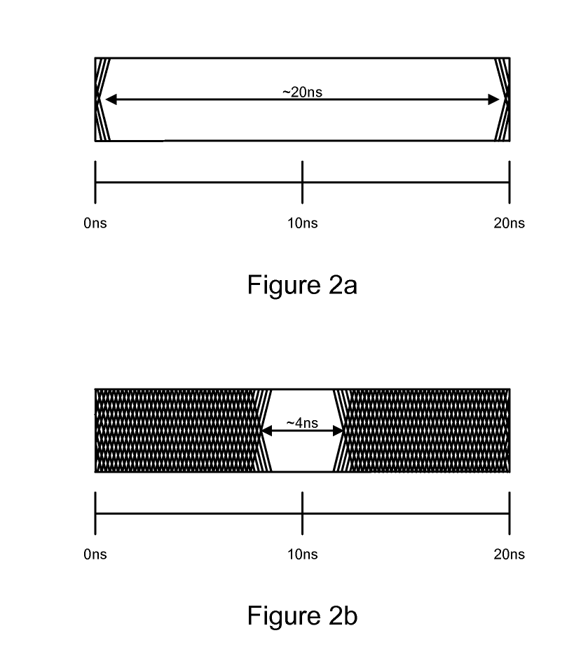

### DETAILED DESCRIPTION OF THE INVENTION

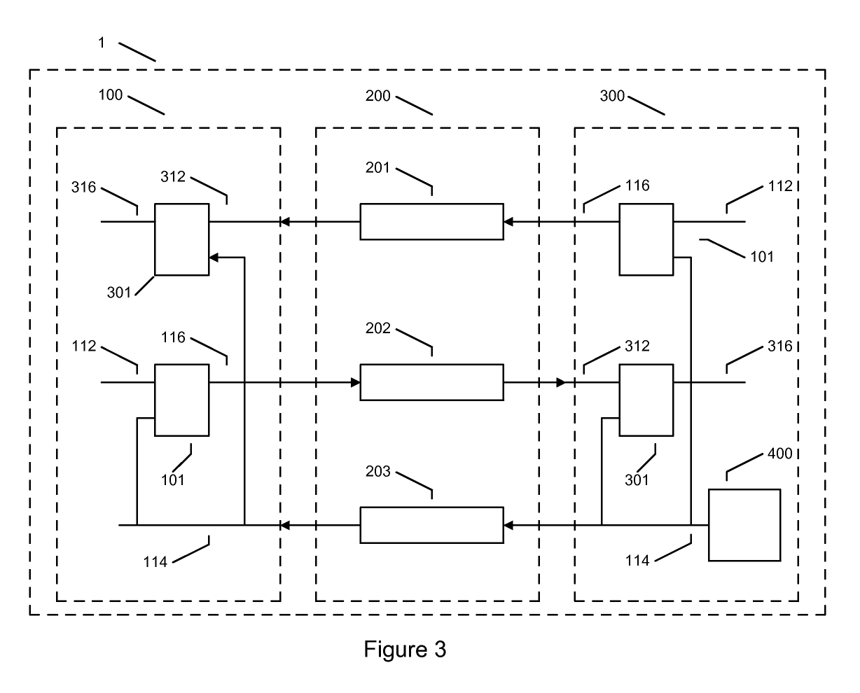

FIG. 3 shows a communications system 1 comprising a first transceiver 300, a second transceiver 100 and a communications channel 200. First transceiver 300 operates as a master supplying a clock through communications channel 200 to second transceiver 100. Alternative embodiments may use a clock source in both first transceiver 300 and second transceiver 100. First transceiver 300 and second transceiver 100 are shown with a single transmitter, 101 and single receiver 301 but may include a plurality of transmitters and receivers, one receiver receiving data from a corresponding transmitter. Each transmitter and receiver pair are shown to use separate unidirectional channels although operation is not restricted to unidirectional channels and a transmitter receiver pair may be combined to operate over a bi-directional channel.

Communications channel 200 comprises a series of networks 201, 202 and 203 that may be electrical or optical in nature, for example but not restricted to, coaxial cable for an electrical channel and fibre optic cable for an optical channel. Networks with electrical properties will be referred to where appropriate without loss of generality in the present invention. A channel network such as network 201 may be formed by wires with a frequency transfer function from the input to the output of the channel network characterised by amplitude and phase variations in frequency. The electrical characteristics of a communications network may result in a requirement that, at the transmitter, a minimum pulse width is specified in order that the pulse is not dispersed throughout the network and can be observed and recovered at the end of the network and receiver input. In this disclosure the minimum pulse width that can be used with a communications network is denoted T_{DMIN}. Another property of a communications network is delay and the delay of a channel network in this disclosure is denoted T_{CHAN}.

An observer looking at the transmitter output signal where a signal is transmitted in synchronism to a clock could quite clearly see the data and, knowing the data transfer rate, sample the data reducing the security of the communications channel. An observer may not so easily observe the data at the receiver input due to dispersion in the communications channel, however, armed with knowledge of clock and data recovery techniques an observer could apply these techniques and make the information even at the receiver input observable.

In the present invention a random or random-like clock period is used to transmit data through a communications channel and close the data eye to render the data more resistant to being monitored by an observer.

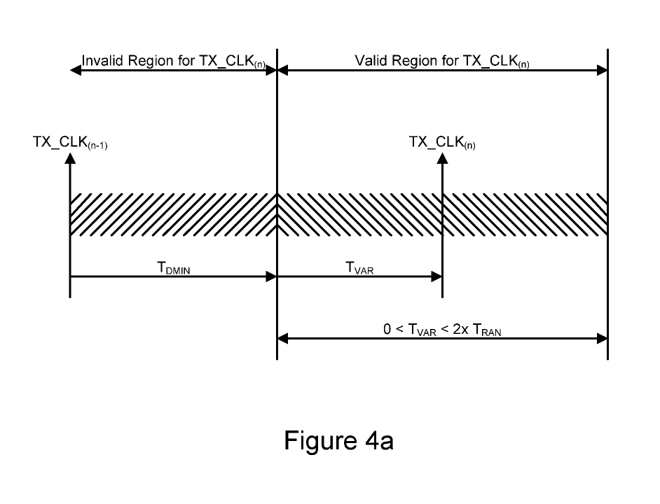

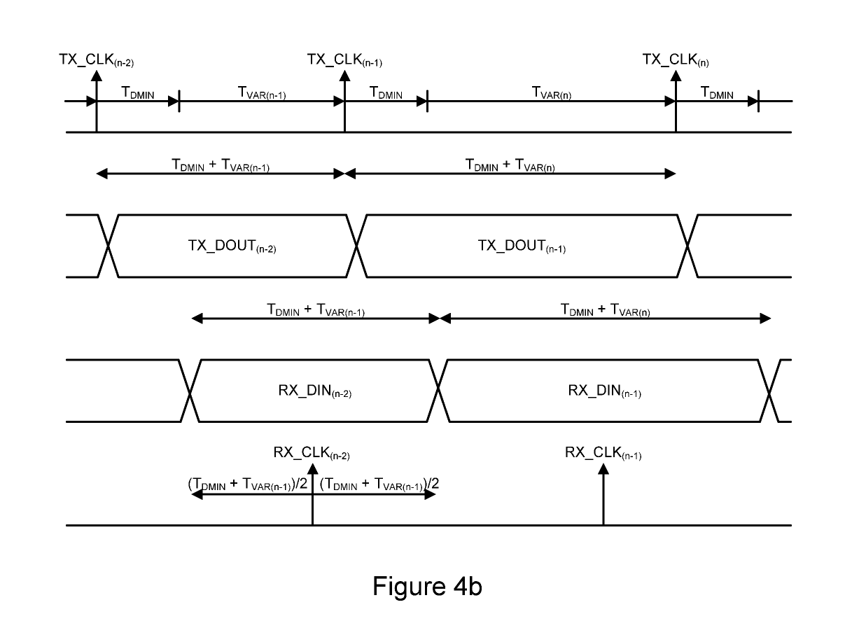

In the present invention the period of the clock synchronising the transmit data does not remain constant as in other communications channels but varies from one cycle to the next cycle. The clock period comprises a fixed part and a variable part. As the minimum pulse input to a network channel is defined as T_{DMIN} then a transmitter is not allowed to transmit data with consecutive edges separated by a time less than T_{DMIN}. This minimum period is determined by the contribution of the random jitter and deterministic jitter that is a characteristic of the channel itself, and other physical factors relating to the driver and receiver design, signal to noise ratio within the channel and the phase distortion of the channel. Accordingly the fixed part of the random clock period is set to a value no less than T_{DMIN}. The variable part of the random clock period is defined as T_{VAR} where 0<T_{VAR}<2×T_{RAN} and T_{RAN} is the amount of random modulation. FIG. 4a shows an example of the random clock timing showing a transmit clock TX_CLK₍ₙ₎ generated from the previous transmit clock TX_CLK₍ₙ₋₁₎ and the valid regions bound by T_{DMIN} and T_{RAN}. It is of particular merit that each edge of the transmit clock is generated from the previous edge and not as an offset to a clock of constant period. In this manner the data is transmitted with a random period bound only by the minimum delay between edges T_{DMIN}, a function of the communications channel, and the amount of random modulation T_{RAN}, set to minimise the data rate reduction that occurs with randomising the transmit clock period while closing the eye diagram.

The time to the next transmit clock can be stated as:

T_{TX}_{_{—}}_{CLK(n)}=T_{DMIN}+T_{VAR(n)} (1)

where T_{VAR(n)} is a random delay. By means of an example, and as shown in FIG. 3, the random delay could be nominally T_{RAN} with a distribution extending from 0 to 2×T_{RAN}.

Accepting that a signal has been launched into a communications channel from a transmitter where the transmit clock has the timing properties shown in FIG. 4a the next step is to understand how the receiver may sample the signal at the output of the communications channel at the correct time.

FIG. 4b shows a timing diagram of the transmit clock, transmit data, delayed transmit data such as may be seen at the output of the communications channel and at the input of the receiver and the optimal receiver clock. It can be seen that if there were no channel delay then the optimal receiver sampling clock would have sampling transitions positioned at the mid-point of each pair of transmit clock transitions. Taking into account the channel delay the receiver sampling clock is then just shifted in time by the channel delay. Accordingly, a receive clock generator needs to be able to determine the separation between each pair of transmit clock transitions and delay the transitions by the delay of the communications channel T_{CHAN}.

The communications channel delay can be absorbed into the receiver sampling clock generator by delaying the start of the receive clock generator by the channel delay. Then, the optimal sampling time of the received data can be determined as:

$${T}_{RX\_CLK ( n - 1 )} = {T}_{DMIN} + [ \frac{{T}_{VAR ( n - 1 )} + {T}_{VAR ( n )}}{2} ] \qquad ( 2 )$$

VAR₍ᵢ₎ represents the delay value of the transmit clock generator associated with the i^{th} transition of the transmit clock generator output signal. The receiver in the present invention includes a means of calculating the same random number sequence and performing the above calculation.

In a communications network, the network properties are rarely known in advance so it is necessary to be able to make a measure of some of the properties in order to initialise the transceivers at either end of the network. In the present invention it is required that the minimum allowable transmit pulse width is known or is determined automatically using a training sequence as part of the start-up initialisation sequence. The present invention includes a means of measuring the channel delay T_{CHAN} and the minimum pulse width T_{DMIN}.

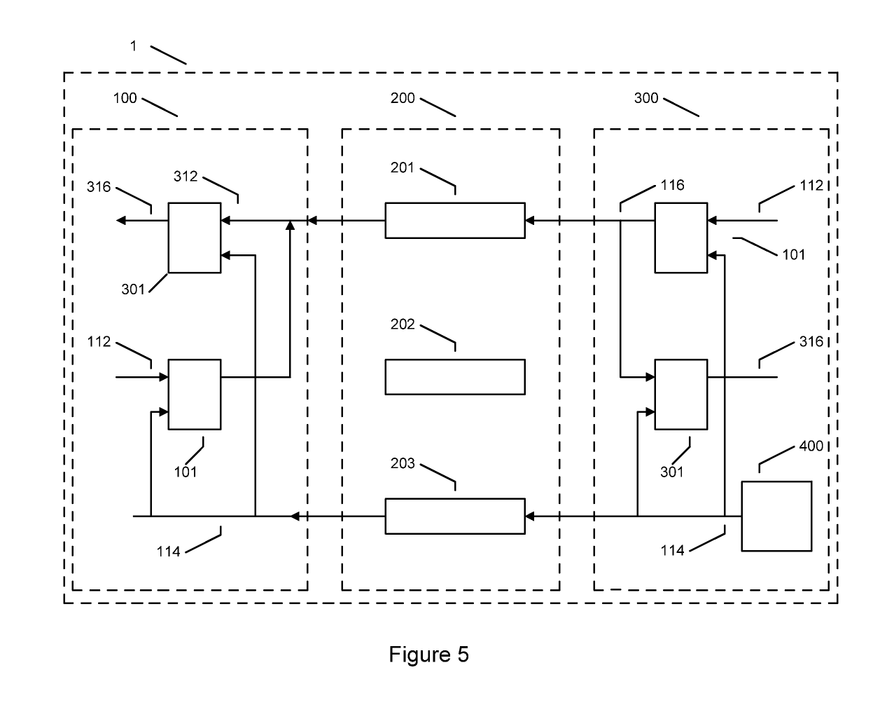

In one embodiment of the present invention the channel delay T_{CHAN} is determined as part of a start-up initialisation sequence. The channel delay can be measured by configuring each end of a network with a transmitter and receiver, reconfiguring the signal routing inside each transceiver device to form a bi-directional communications link with a transmitter and receiver connected to each end of the communications channel. FIG. 5 shows a master transceiver 300, a slave transceiver 100 and a communications channel 200. Master transceiver 300 and slave transceiver 100 are both configured with a transmitter 101 and a receiver 301 connected to form a bi-directional communications link through communications network 201. At start-up master transceiver 300 is configured as a transmitter while slave transceiver 100 is configured as a receiver. Master transceiver 300 transmits a signal from transmitter 101 through communications network 201 to slave transceiver 100, slave transceiver 100 receiving the transmitted signal after the channel delay T_{CHAN}. In one embodiment of the present invention signals may be transmitted through the communications channel by changing the state from a logic-1 state to a logic-0 state, the logic-1 state being a pull-up state that can be safely over-driven by either transmitter. A protocol is defined in each transceiver so that it is not possible for the transmitters in both transceivers to communicate at the same time. Prior to the start of any transmissions the output of transmitter 101 in master transceiver 300, signal 116, will be at a logic-1 state. Transmitter 101 in master transceiver 300 then sets the output 116 to a logic-0 state and, after a delay reverts to the logic-1 state forming the channel delay measurement pulse, the pulse width larger than the anticipated channel delay. Coincident with the generation of the channel delay measurement pulse transmitter 101 in master transceiver 300 starts a channel measurement timer. The pulse generated by master transceiver 300 propagates through communications network 201 and is received at the receiver input 312 of receiver 301 in slave transceiver 100. On receipt of a pulse receiver 301 in slave transceiver 100 waits for the end of the pulse then further waits a fixed period of time, known to both master and slave transceiver, generating a return pulse to master transceiver 100 simultaneously starting a channel measurement timer in transceiver 100. Master transceiver 300 detects the return pulse and is then able to determine the channel delay, the total time from transmitting a signal to receiving a signal is 2×T_{CHAN}+T_{KNOWN} where T_{CHAN} is the channel delay time and T_{KNOWN} is the time turn-around delay known to both master transceiver 300 and slave transceiver 100. Transmitter 101 in master transceiver 300 then waits T_{KNOWN} and returns a pulse to slave transceiver 100. On receipt of the returned pulse slave transceiver detects the pulse and performs the same calculation to determine the channel delay. At that point both master transceiver 300 and slave transceiver 100 have measured the channel delay and are synchronised but the minimum separation of edges imposed by the communications channel still remains unknown. To determine the minimum pulse width the above process is then repeated over and over again each time master transceiver 300 generating a narrower and narrower pulse width until such time as the pulse is too small to propagate through communications channel 200 and the absence of a pulse at slave transceiver 100 is detected by a watchdog timer expiring. Slave transceiver 100 then is able to transmit a coded signal back to master transceiver 300 and both ends of the communications link know the minimum pulse width that can be passed in communications network 201 and communications network 201. At this point both master transceiver 300 and slave 100 are synchronised and know the channel delay T_{CHAN} and minimum pulse width T_{DMIN} that can be handled by communications network 201. Knowing the minimum pulse width that the channel is capable of transmitting and successfully receiving and having synchronised the transceivers at both ends of the channel communications can then start.

In some applications the minimum pulse width measured by each transceiver may be very short and would, if not corrected, result in the minimum clock period produced by the transmit clock generator 120 or receive clock generator 320 being shorter than the processing time of the logic calculating the timing transitions. The maximum propagation delay through the logic of transmit clock generator 120 and receive clock generator 320 may be determined prior to manufacture of the communications devices and could be used along with additional circuitry to detect whether the result from the measurement of the minimum pulse width is too small. On detecting such a case then it would be possible to purposely add delay into one or both transceivers 100 and 300 to increase the minimum pulse width. One embodiment of such a scheme to detect and correct for too low a value for the minimum pulse width comprises: a means of determining the maximum propagation delay through the transceiver clock generator circuit, preferably through simulation; a means of programming this information into the device, for example with fusible links or flash memory; a comparator to detect when the value of the measured minimum pulse width is too small providing an input signal to the start-up or initialisation state machine and enhancement of the start machine to accept this new input signal and add delay into the transmitted or received signal path. By means of an example, consider a communications channel where copper cables were used to connect first transceiver 100 to second transceiver 300 where the transmitter output stage of each transceiver included a resistive load, then capacitance could be added to the output stage to increase the minimum pulse width allowed in the communications channel. Other methods exist to add delay into the communications channel and would include, but are not limited to, adding delay at other locations in one or both transceivers, for example adding a programmable delay line between the transmitter output and receiver input.

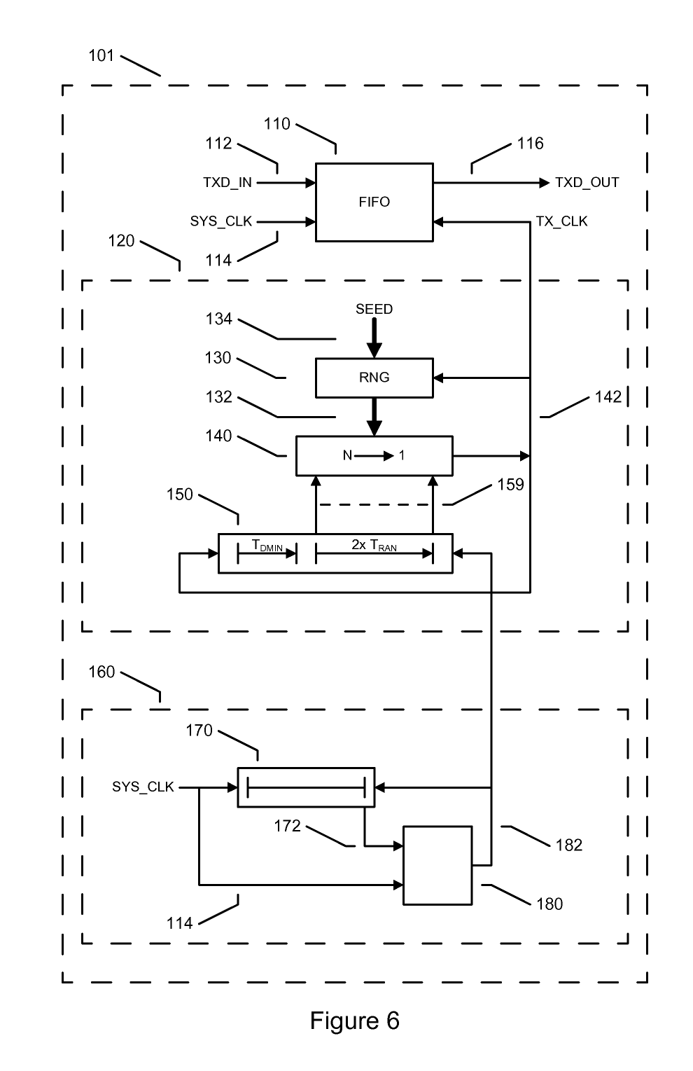

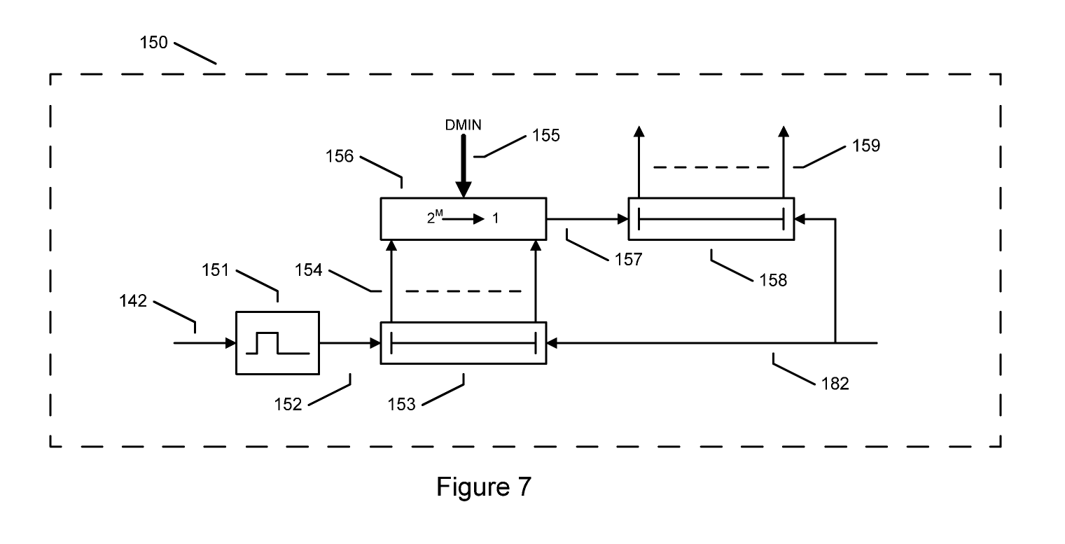

FIG. 6 shows one embodiment of transmitter 101 in master transceiver 300 or slave transceiver 100 comprising: transmit clock generator 120; delay locked loop 160 and a first-in first out data buffer (FIFO) 110. Transmit clock generator 120 generates a clock to synchronise data transmitted from the device with a random period and ensuring data eye closure comprising: random number generator 130; delay line 150 and multiplexer 140. Random number generator 130 is clocked by the transmit clock generator output clock 142 producing a random number 132 every clock cycle and may, for example, comprise synchronous and asynchronous logic elements connected to form a maximal length shift register, said random number generator initialised with a seed 134 known to both transmitter and receiver. Delay line 150 and multiplexer 140 comprise a means of generating a transmit clock pulse, taking as input the transmit clock generator output clock 142 and producing an output pulse delayed by a random amount consisting of a fixed part T_{DMIN} and a variable part T_{VAR}. FIG. 7 shows an embodiment of delay line 150 in more detail with delay line 150 comprising: monostable 151 producing a pulse 152 from one edge of the delay line input signal 142, said pulse of nominally fixed width less than T_{DMIN} and injected into a first delay stage 153. First delay stage 153 comprises a number of nominally identically delay cells connected in series to produce a maximum delay equal to the sum of the delays of each individual cell. Each delay cell in first delay stage 153 has a common control input 182 that is used to control the delay and maintain the delay of each cell nominally constant over process, voltage and temperature variations. The output of each delay cell in delay stage 153 forms bus 154 and said bus is input to data selector 156 with control bus 155 selecting one of first delay stage 153 outputs in accordance with the contents of delay selection bus 155, producing first delay stage output signal 157. The number of delay cells in first delay stage 153 is a function of the delay time range and the time quantisation required for T_{DMIN}. For example, an application may require T_{DMIN} to cover the range 100 ns to 200 ns with a step size of 1 ns. The delay cell would be designed to produce a delay of 1 ns, the first delay stage 153 could comprise 255 such stages. The bus formed by signal 152 and the outputs of each delay cell in the first delay stage 153 would form a 256 bit bus 154 to data selector 156. Bus 155 would be an 8-bit bus and capable of selecting a delayed signal between 0 ns (monostable 151 output signal 152) and 255 ns (the maximum delay produced by first delay stage 153). In practice there is a minimum delay setting due to propagation delay through the monostable.

The first delay stage output signal 157 is input to second delay stage 158, also comprising a number of delay cells, the delay cells connected in series producing a maximum delay equal to the sum of the delays of each cell. Each delay cell in second delay stage 158 has a common control input 182 that is used to control the delay and maintain the delay of each cell nominally constant over process, voltage and temperature variations. The output of each delay cell in second delay stage 158 forms bus 159 and said bus is input to data selector 140 where one pulse is selected according to the data word generated by random number generator bus 132.

Other means of implementing the delay stages in delay line 150 are obvious to someone practiced in the art such as, for example, a delay line comprising a coarse delay stage and a fine delay stage the two stages connected in series, some bits of the delay control bus controlling the coarse delay line and the remaining bits controlling the fine delay line. Another example of a delay line that avoids the use of a large multiplexer is to use a delay line with relatively large delay duration per delay cell and then interpolate between the output signals from two adjacent delay cells.

Delay line 150 needs to be initialised in order to start correctly. The delay line must be cleared of any signals passing through the delay line in order to ensure that only one pulse is propagating through the delay line. In one embodiment this is achieved by gating the feedback signal holding the input to monostable 151 until synchronisation is achieved between master transceiver 300 and slave transceiver 100. Further, the measurement of the communications channel delay is used to setup DMIN 155 to first delay stage data selector 156 producing delay T_{DMIN}. During initialisation transmit clock generator 120 is held in a static state until the minimum pulse width period T_{DMIN} is known and the system clock used as the transmit clock generator output clock.

FIFO 110 is used to provide a means of handling data transfers between two different asynchronous domains, the system clock domain, a fixed clock period, and the transmit clock generator clock a variable period clock. The FIFO must be at least partially filled before starting the transmit clock generator in order to avoid the FIFO emptying. FIFO 110 has a data input 112 the data clocked into the FIFO by the system clock SYS_CLK 114. FIFO 110 has a data output 116 produced by the action of transmit clock generator output clock 142.

Delay locked loop 160 is used to ensure that delays produced by delay line 150 are constant over process, voltage and temperature variations. Delay locked loop 160 comprises delay line 170, preferably of the same design, same layout, same layout orientation and in close proximity to delay line 150 and phase detector 180. System clock 114 is input to delay line 170, passing through a monostable also present in delay line 150, delay line 170 producing an output signal 172 nominally delayed by one period of system clock 114. Delay line 170 output signal 172 and system clock input 114 are input to the phase detector 180, the phase difference between signal 172 and signal 114 filtered and providing control signal 182 used to maintain the total delay in delay line 170 equal to the period of system clock 114. Control signal 182 is connected to the control input of delay line 150 to minimise delay variations in delay line 150.

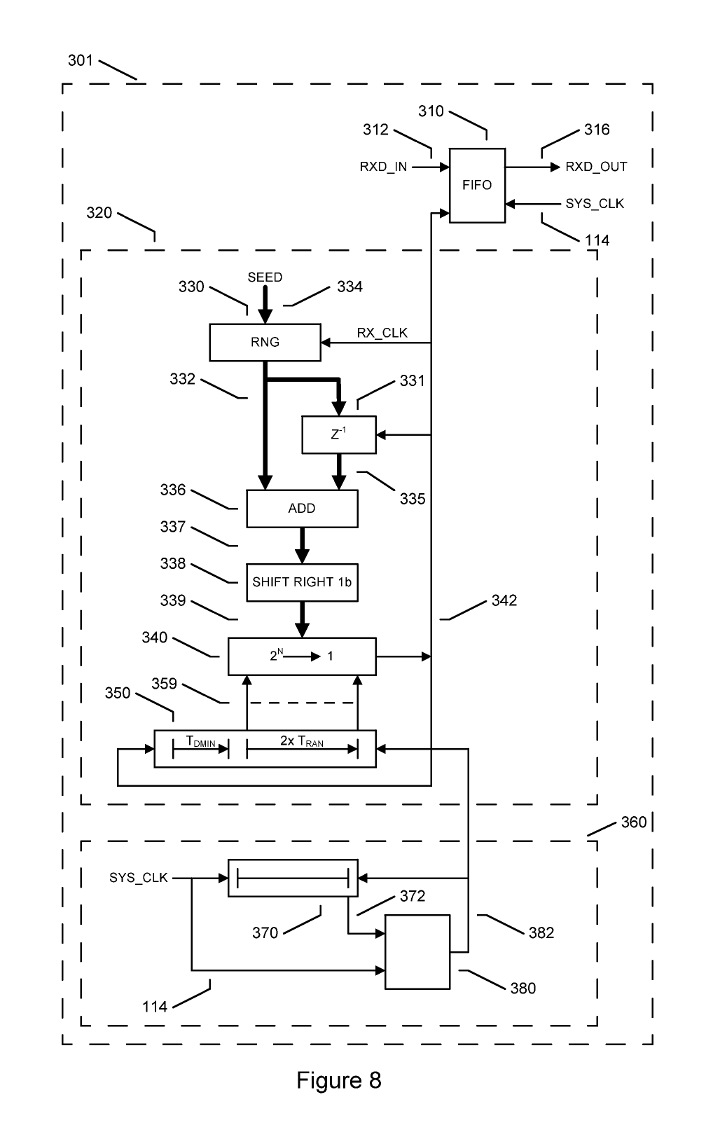

FIG. 8 shows a first embodiment of receiver 301 in master transceiver 300 or slave transceiver 100 comprising: receive clock generator 320; delay locked loop 360 and data buffer, a FIFO, 310. Receive clock generator 320 generates a clock to synchronise the received data transmitted from either a master transceiver or slave transceiver with a random period to ensure data eye closure comprising: random number generator 330; delay line 350 and multiplexer 340. Random number generator 330 is clocked by the receive clock generator output clock 342 producing a random number every clock cycle and may, for example, comprise synchronous and asynchronous logic elements connected to form a maximal length shift register, said random number generator initialised with a seed 334 known to both transmitter and receiver. Random number generator output 332 is delayed by register 331 clocked by the clock output signal 342 producing output 335, a delayed copy of random number generator output 332. The random number generator output 332 and the delayed copy 335 are added in adder 336 producing the output 337 that is then right shifted by network 338, effectively dividing the result 337 by two producing the control word 339 to multiplexer 340.

Delay line 350 and multiplexer 340 comprise a means of generating a receive clock pulse, taking as input the receive clock generator output clock 342 and producing an output pulse delayed by a random amount consisting of a fixed part T_{DMIN} and a variable part T_{VAR}. Delay line 150 and delay line 350 are substantially equivalent.

FIFO 310 is used to provide a means of handling data transfers between two different asynchronous domains, the receiver random clock generator clock domain, a variable period clock and the system clock generator, a fixed clock period. The FIFO must be at least partially filled before starting clocking data out by the system clock in order to avoid the FIFO emptying. FIFO 310 has a data input 312 clocked into the FIFO at times defined by receive random clock generator output clock 342. FIFO 310 has a data output 316 produced buy the action of system clock SYS_CLK 114.

Delay locked loop 360 is used to ensure that delays produced by delay line 350 are constant over process, voltage and temperature variations. Delay locked loop 360 comprises delay line 370, preferably of the same design, same layout, same layout orientation and in close proximity to delay line 350 and phase detector 380. System clock 114 is input to delay line 370, passing through a monostable also present in delay line 350, delay line 370 producing an output signal 372 nominally delayed by one period of system clock 114. Delay line 370 output signal 372 and system clock input 114 are input to the phase detector 380, the phase difference between signal 372 and signal 114 filtered and providing control signal 382 used to maintain the total delay in delay line 370 equal to the period of system clock 114. Control signal 382 is connected to the control input of delay line 350 to minimise delay variations in delay line 350.

It is recognised that the same delay locked loop may be used to produce the delay line control signal 182 or 382 for one or several delay lines in a transceiver.

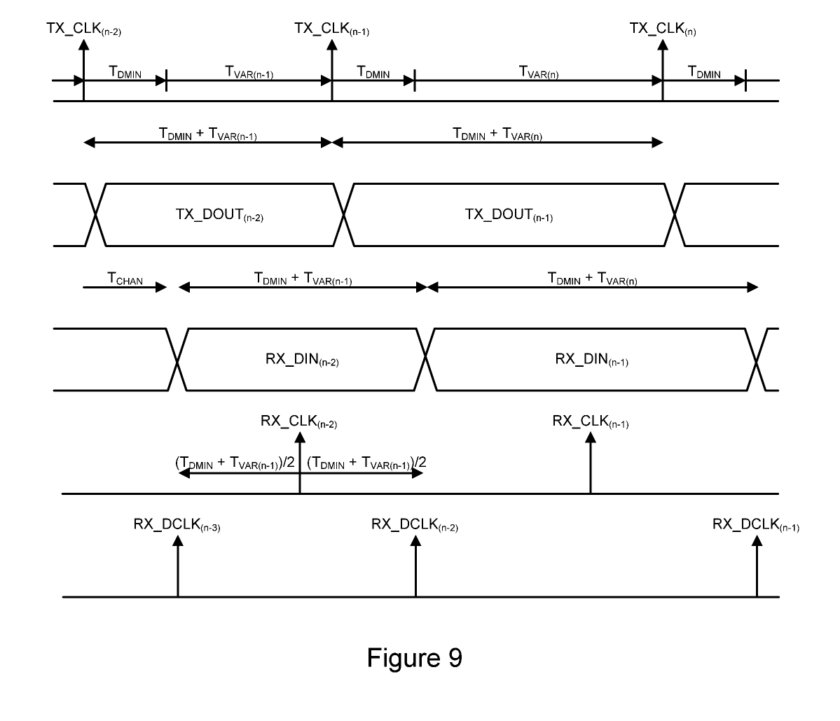

It is common in many communications systems to include a clock and data recovery circuit which can generate a clock locked to the received data. It is particularly useful in some embodiments of the present invention to retain synchronism of the received data to the random clock generator output clock. One method often employed in clock and data recovery is to produce a received data sampling clock that is aligned to the data and another clock that is 90° out of phase with the received data sampling clock. The second clock then aligns to the data transitions and can be used to detect when frequency or phase shifts occur in the received data sampling clock. FIG. 9 shows a timing diagram where a second receiver clock generator output clock 395 is shown aligned to the receiver input 312 data transitions. The time between adjacent receive data transitions generated from TX_CLK₍ₙ₋₂₎ and TX_CLK₍ₙ₋₁₎ is:

T_{RX}_{_{—}}_{CLK(n-1)}−T_{RX}_{_{—}}_{CLK(n-2)}=T_{DMIN}+T_{VAR(n-1)} (3)

The time between the RX_CLK₍ₙ₋₂₎ sampling point and the previous or following receive data edge is half of this time:

$${T}_{RX\_DCLK ( n - 2 )} - {T}_{RX\_CLK ( n - 2 )} = \frac{( {T}_{DMIN} + {T}_{VAR ( n - 1 )} )}{2} \qquad ( 4 )$$

As the values of T_{DMIN} and T_{VAR(n-1)} are known it is possible to generate a sampling clock that should be coincident with the receive data transitions when the receive sampling clock is correctly aligned to the mid-point of adjacent transitions. Once such a clock is generated then it is possible to perform clock and data recovery on the received data even though the data period has been randomised.

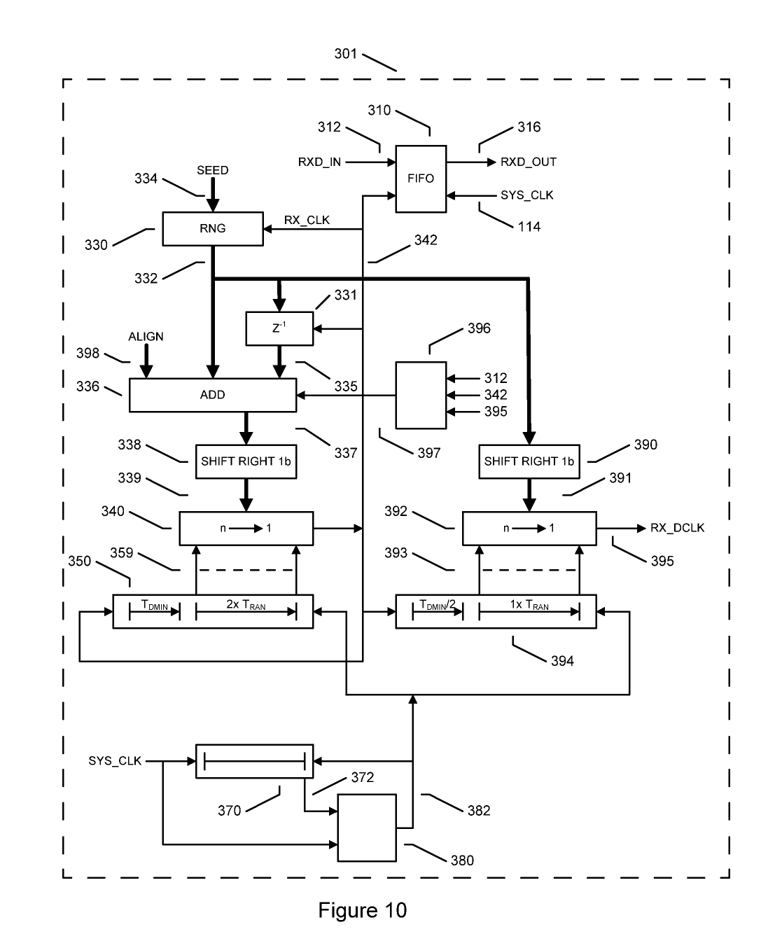

FIG. 10 shows one embodiment of the enhanced receiver clock generator circuit producing the second receiver clock RX_DCLK 395. The output of random number generator 330 is shifted right with shifter 390 producing bus 391 the value of which is half the value of random number generator output 332. Delay line 394 takes receive clock generator output clock 342 as input delaying the clock 342 by T_{DMIN}/2 and further delaying clock 342 by a time T_{VAR(n-1)}/2. Methods to implement delay lines have already been discussed and are applicable to delay line 394 producing a plurality of output signals in bus 393, multiplexer 392 selecting one of the delayed clock signals in bus 393 by T_{DMIN}/2 producing second receive clock 395. In one embodiment of present invention phase detector 396 has as inputs received data input 312, receiver clock generator first clock 342 and receiver second clock generator second clock 395, phase detector 396 producing output signal 397 when the receiver clock generator second clock 395 is not aligned to data edges and forces a phase shift by, for example, the addition or subtraction of an amount ALIGN 398 to bus 337, incrementing or decrementing bus 337 depending on whether the phase of the receive clock 342 needs to be retarded or advanced. Phase detector may include a means of filtering, for example a digital filter, removing noise that occurs when second receiver clock 395 is moving from one side to the other side of transitions of receive data 312.

It has herein been shown that in a preferred embodiment of the present invention the technique of closing the eye diagram of a transmitted signal within a communications system is beneficial to enhancing the security of said communications system. A technique has been shown whereby a transmitter and receiver in a communications system can be initialised to synchronise the transmit clock generator to the receive clock generator while at the same time measuring the channel delay and the minimum allowable transmit pulse width. Further, a technique has been disclosed for constructing a transmit clock generator where the transmit clock generator period is bounded by the minimum allowable transmit pulse width. Yet further a technique has been disclosed for constructing a receive clock generator that can calculate the optimal sampling point of the received data, with a means of clock tracking.

The present invention would preferably used in conjunction with an algorithmic encryption scheme, which has the characteristics of a random like data stream, such that the data itself is not observable by using very high speed capture tools.

In channels with high bandwidth, such as optical channels and high speed copper channels, the bandwidth available is often much more than the bandwidth required by the application. The security of the channel may be enhanced further by adding random data to the secure data such that the available spectrum is filled with noise from these other transitions. The random data that is added in this way can be completely random, such as from a band-gap noise source within the system. The overlap of the pseudo-random sequence and the truly random sequence, can be made statistically indistinguishable. The absence of the noise data or uneven distribution of the random noise data may be monitored to detect tampering with the transmitter or receiver and shut down all functions within the channel.

We claim:

1. A communications system with improved security for preventing or at least making difficult the observation, recovery and modification of the data within the communications channel, the system comprising:
1a. a communications channel with a plurality of communications networks, each communications network comprising a first port, a second port and a means of transferring data between the first port and second port;
1b. a first transceiver with a plurality of transmitters and a plurality of receivers, wherein each transmitter output is connected to a first port of a communications network and each receiver input is connected to a first port of a communications network, and wherein data is transmitted from each transmitter output through the communications network to a second port, and data is received at each receiver input having been transmitted from a second port of a communications network, the first transceiver configured as a master device. and
1c. a second transceiver with a plurality of receivers and a plurality of transmitters, wherein each receiver input is connected to a second port of a communications network and each transmitter output is connected to a second port of a communications network, and wherein data is received at each receiver input through the communications network having been transmitted from a first transceiver, and the transmitter is connected to the first port of said communications network, and wherein data is transmitted at each transmitter output and received at a first port of a communications network in the first transceiver, and wherein the second transceiver is configured as a slave device.

2. A communications system according to claim 1, wherein the said transmitter comprises:
2a. a transmit data buffer configured as a first-in first-out buffer comprising a data input, a clock input for clocking input data into the transmit data buffer, a data output and an output clock for clocking output data out of the buffer, wherein the transmit data buffer is used to synchronise the data flow between the input clock domain and the output clock domain;
2b. a transmit clock generator producing a clock with transitions separated in time, wherein the separation of adjacent transitions consists of a fixed period and a variable period, the fixed period set by the minimum pulse width capable of passing through the communications network; and
2c. a delay locked loop for maintaining the fixed delay and variable periods substantially independent of process, supply voltage and temperature variations.

3. A communications system according to claim 1, wherein the said receiver comprises:
3a. a receive data buffer configured as a first-in first-out buffer comprising a data input, a clock input for clocking input data into the receive data buffer, a data output and an output clock for clocking output data out of the buffer, the receive data buffer used to synchronise the data flow between the input clock domain and the output clock domain;
3b. a receive clock generator producing a clock with transitions separated in time, the separation of adjacent transitions calculated to correspond to the optimal sampling point of the received data;
3c. a delay locked loop for maintaining the variation in receiver sampling clock transitions substantially independent of process, supply voltage and temperature variations.

4. A communications system according to claim 2, wherein the transmit clock generator for producing an output clock comprises:
4a. a random number generator, clocked by the output clock, producing random numbers each output clock cycle, the random number generator seeded with a value known to both first transceiver and second transceiver;
4b. a delay line with a monostable, a first delay stage and a second delay stage, the monostable producing a pulse in response to a transition at the input of the monostable, the delay in the first delay stage determined from the value of a data word defining the minimum separation between adjacent transmit data output transitions, the output of the first delay stage connected to the input of the second delay stage, the delay in the second delay stage determined from the value of the random number generator output bus, producing a single output pulse, the transmit clock generator output clock, the delay variation in the delay line controlled by a control input signal generated by the delay locked loop maintaining the delay variation constant over process, supply voltage and temperature.

5. A communications system according to claim 3, wherein the receive clock generator for producing an output clock for sampling the received data at the optimal sampling point comprises:
5a. a random number generator, clocked by the output clock, producing random numbers each output clock cycle, the random number generator seeded with a value known to both first transceiver and second transceiver;
5b. a register delaying the output of the random number generator one receive clock generator output clock cycle;
5c. an adder for adding the output of the random number generator and the output of the register holding the previous value of the random number generator, the output of the adder shifted one bit from the most significant bit to the next lower significant bit causing the result of the addition process to be halved producing an output data word indicating the partial result of the delay time calculation of the optimal sampling point of the next received data bit;
5d. a delay line with a monostable, a first delay stage and a second delay stage, the monostable producing a pulse in response to a transition at the input of the monostable, the delay in the first delay stage determined from the value of a data word defining the minimum separation between adjacent transmit data output transitions, the output of the first delay stage connected to the input of the second delay stage, the delay in the second delay stage determined from the value of the random number generator output bus, producing a single output pulse, the receive clock generator output clock, the delay variation in the delay line controlled by a control input signal generated by the delay locked loop maintaining the delay variation constant over process, supply voltage and temperature.

6. A communications system according to claim 3 wherein the receive clock generator for producing a first output clock for sampling the received data at the optimal sampling point and a second output clock for sampling the transitions in the received data comprises:
6a. a random number generator, clocked by the output clock, producing random numbers each output clock cycle, the random number generator seeded with a value known to both first transceiver and second transceiver;
6b. a register delaying the output of the random number generator one receive clock generator output clock cycle;
6c. a first adder for adding the output of the random number generator and the output of the register holding the previous value of the random number generator, the output of the first adder shifted one bit from the most significant bit to the next lower significant bit causing the result of the addition process to be halved producing an output data word indicating the partial result of the delay time calculation of the optimal sampling point of the next received data bit prior to the data alignment controller output bus;
6d. a second adder with a first input the output of the first adder, a second input the data alignment controller output bus generating a modified output data word indicating the partial result of the delay time calculation of the optimal sampling point of the next received data bit after correction by the data alignment controller output bus;
6e. a delay line with a monostable, a first delay stage and a second delay stage, the monostable producing a pulse in response to a transition at the input of the monostable, the delay in the first delay stage determined from the value of a data word defining the minimum separation between adjacent transmit data output transitions, the output of the first delay stage connected to the input of the second delay stage, the delay in the second delay stage determined from the value of the random number generator output bus, producing a single output pulse, the receive clock generator output clock, the delay variation in the delay line controlled by a control input signal generated by the delay locked loop maintaining the delay variation constant over process, supply voltage and temperature.
6f. a second delay line with a first delay stage and second delay stage, the first delay stage controlled by a data word with a value representing half of the minimum pulse width passable by the communications network, the second delay stage being controlled by the output of the random number generator, the output of the random number generator shifted one bit from the most significant bit to the next lower significant bit, the random number generator output number being halved, the second delay line producing an output pulse aligned to the next data transition;
6g. a data alignment controller comprising: a first input clock, the receive clock generator first output clock nominally aligned to the centre of the received data bits; a second input clock, the receive clock generator second output clock, nominally aligned to the received data transitions, and a third input, the received data, the first input clock and second input clock each sampling the received data and determining if there is a data transition and whether the data transition is early or late generating an output control signal to advance or retard the delay calculated for the optimal sampling point of the received data.

7. A communications system according to claim 2, wherein the said delay locked loop comprises:
7a. a delay line formed with cells of the same electrical design as those in the delay stages of the delay lines in the transmit clock generator and receive clock generator, the system clock of each transceiver connected to the delay line input, the delay line producing an output signal delayed with respect to the input signal;
7b. a phase detector with a first input connected to the transceiver system clock, a second input connected to the delay locked loop delay line output signal, the phase detector producing an output control signal relative to the phase difference between the first input and second input, the output control signal used to control the delay of the cells in the delay line maintaining the delay constant over process, voltage and temperature variations.

8. A method of enhancing the security of a communications system for preventing or at least making difficult the observation, recovery and modification of the data within the communications channel, comprising:
8a. transmitting data over a communications channel with a plurality of communications networks, each communications network comprising a first port, a second port and a means of transferring data between the first port and second port;
8b. providing a first transceiver with a plurality of transmitters and a plurality of receivers, wherein each transmitter output is connected to a first port of a communications network and each receiver input connected to a first port of a communications network, wherein data is transmitted from each transmitter output through the communications network to a second port, and data is received at each receiver input having been transmitted from a second port of a communications network, the first transceiver configured as a master device;
8c. providing a second transceiver with a plurality of receivers and a plurality of transmitters, wherein each receiver input is connected to a second port of a communications network and each transmitter output is connected to a second port of a communications network, wherein the data is received at each receiver input through the communications network having been transmitted from a first transceiver transmitter connected to the first port of said communications network, and data is transmitted at each transmitter output and being received at a first port of a communications network in the first transceiver, the second transceiver configured as a slave device.

9. A method of enhancing the security of a communications system according to claim 8, comprising a step of producing a clock with transitions separated in time using a transmit clock generator, wherein the separation of adjacent transitions consists of a fixed period and a variable period, the fixed period set by the minimum pulse width capable of passing through the communications network.

10. A method of enhancing the security of a communications system according to claim 8, comprising a step of producing a clock with transitions separated in time, wherein the separation of adjacent transitions is calculated to correspond to the optimal sampling point of the received data.

11. A method of enhancing the security of a communications system according to claim 8, comprising a step of producing a first clock with transitions separated in time, wherein the separation of adjacent transitions is calculated to correspond to the optimal sampling point of the received data and a second clock with transitions separated in time, the separation of the second clock transitions calculated to correspond to the transitions in the received data signal, and a step of producing an error signal produced when second clock and received data transitions do not align resulting in the introduction of a correction term to subsequent calculations of the optimal sampling point of the received data.

12. A method of enhancing the security of a communications system according to claim 8 further comprising a step of configuring each transmitter output pin as a transmitter/receiver and each receiver input pin as a receiver/transmitter allowing the of measurement of the channel delay and minimum allowable transmit pulse width.

13. A method of enhancing the security of a communications system of claim 8 further comprising a step of adding a delay to a signal transmitted from the transceiver or a signal received by the transceiver resulting in an increase in the minimum allowable pulse width overcoming any limitation on the minimum pulse width imposed by the timing of one or more signal paths in the transceiver.

14. A method of enhancing the security of a communications system according to claim 8 further comprising a step of initialising the transmit clock generator in the first transceiver and the receive clock generator in the second transceiver and removing the channel delay from the calculation of the delay line time delay value in the receive clock generator.

15. A communications channel with a plurality of communications networks, each communications network comprising a first port, a second port and a means of transferring data between the first port and second port using a system with improved security according to claim 1, wherein random or random-like idle data is added to the encoded data sent over the channel to use a larger proportion of the available bandwidth of the channel than is required to send the secure data.
